(19) United States
(12) Patent Application Publication
(10) Pub. No.: US 2013/0102449 A1
(43) Pub. Date: Apr. 25, 2013

(54) PERFORATION SCORING ON EXTRUDED FILM

(71) Applicants: Jim Graboski, Moneta, VA (US); John Ericson, Armonk, NY (US)

(72) Inventors: Jim Graboski, Moneta, VA (US); John Ericson, Armonk, NY (US)

(21) Appl. No.: 13/276,720

(22) Filed: Oct. 19, 2011

(51) Int. Cl. B31B 1/14

(52) U.S. Cl. 493/340

(57) ABSTRACT

Systems, methods, and devices are provided for applying a perforation layout to an extruded film. The extruded film may be processed into film roil stock used to make individual perforated bags. A perforation layout is determined based on a desired perforation design for individual bags, and the determined layout is applied to the film by a perforating element. A variety of different perforations are accommodated by a variable perforating machine that produces perforations of different size, spacing, uniformity, and linearity. A laser perforating element may be implemented and controlled by a programming module configured to produce a particular perforation.

### BACKGROUND

Perforated packaging is utilized to provide a bag that is easy to open and requires little effort to access contents of the bag. Perforating a bag near the top of the bag creates a tear strip for opening. The tear strip provides a mechanism to easily access the contents of the bag by tearing along the perforation.

Current approaches provide for perforating bags after the bags are filled and sealed. A bag is formed by folding a plastic sheet, or overlaying two separate sheets of the same shape and size, and sealing the bag such that one side is left open. The bag is filled through the open side, which is then sealed. To create a perforation on the bag, the sealed bag is passed through a machine that forms a series of holes into the bag to create a perforation having a desired size and shape.

The dimensions and configuration of a bag perforation may be selected to suit a particular application. A certain size, shape, location, and spacing of perforation holes may be desired, and a perforation may be continuous or non-continuous, and linear or non-linear, to create a suitable bag.

Perforating sealed bags requires perforating machines at sites where bags are filled and sealed. This requires more space, machinery, and operators to fill, seal, and perforate bags at a single site. In addition, current perforating machines suffer from a lack of variability and adjustability that is needed to produce bags for different applications.

### SUMMARY

Disclosed herein are systems, devices, and methods for applying perforations to extruded film. The systems, devices, and methods may be incorporated into a production machine used to make extruded films or into post-processing equipment, and can produce an extruded film for bags that contain a desired perforation prior to cutting, filling, and sealing of individual bags. Also disclosed herein are systems, devices, and methods that are configurable to produce multiple varied perforations without requiring extensive changes or modifications to perforating equipment.

In some embodiments, a method for producing a perforated extruded film includes defining a bag perforation design, determining a perforation layout for an extruded film, wherein the perforation layout comprises a plurality of consecutive perforations matching the perforation design, configuring a perforating element to produce the perforation layout on the extruded film, and tracking the extruded film by the perforating element, wherein the perforating element applies the selected perforation layout as the extruded film tracks by the perforating element.

In certain implementations, determining a perforation layout includes defining a shape of holes in a perforation. The shape may be a non-circular shape comprising points that focus stresses, and more than one shape may be defined for a perforation having non-uniform hole shapes.

In certain implementations, determining a perforation layout includes defining a spacing between holes of a perforation, and the defined spacing varies along the extruded film.

In certain implementations, determining a configuration layout includes defining a non-linear pattern for a perforation.

In certain implementations, the method includes determining a repeating pattern of individual operating routines for the perforating element. Determining the repeating pattern includes determining a timing of the individual operating routines such that each operating routine covers a predetermined distance along the extruded film. The predetermined distance is a desired dimension for an individual bag.

In certain implementations, the perforating element is a laser, and configuring the perforating element includes programming at least one of a beam width, beam intensity, pulse rate, and duty cycle of the laser.

In certain implementations, the perforating element is a mechanical perforator, and configuring the perforating element includes selecting at least one of a punch size, punch spacing, and punch shape of the mechanical perforator.

In some embodiments, an extruded film for production of perforated bags is prepared by a process including defining a bag perforation design, determining a perforation layout for an extruded film, wherein the perforation layout includes a plurality of consecutive perforations matching the perforation design, configuring a perforating element to produce the perforation layout on the extruded film, and tracking the extruded film by the perforating element, wherein the perforating element applies the determined perforation layout as the extruded film tracks by the perforating element.

In certain implementations, the perforation layout is applied by a mechanical perforating element. In certain implementations, the perforation layout is applied by a laser perforating element.

In some embodiments, a system for producing a perforated. extruded film includes a laser configured to apply a desired perforation layout to an extruded film, said perforation layout comprising a plurality of consecutive individual tag perforations, a tracking mechanism configured to track the extruded film by the laser, and a programming module configured to control the laser as the extruded film tracks by the laser. The programming module is configurable by a user to produce the desired perforation layout.

In certain implementations, the programming module is configurable to produce at least one of a non-uniform, non-continuous, or non-linear perforation layout.

### BRIEF DESCRIPTION OF THE DRAWINGS

Further features of the invention, its nature and various advantages will be apparent upon consideration of the following detailed description, taken in conjunction with the accompanying drawings, in which like reference characters refer to like parts throughout, and in which:

FIG. 1 shows an illustrative extruded film with center perforations;

FIG. 2 shows an illustrative extruded film folded along a center line of the film;

FIG. 3 shows an illustrative bag with a linear perforation;

FIG. 4 shows an illustrative extruded film with peripheral perforations;

FIG. 5 shows an illustrative extruded film folded along a center line of the film;

FIG. 6 shows an illustrative bag with a linear perforation;

FIG. 7 shows an illustrative bag with a linear perforation and increased hole spacing;

FIG. 8 shows an illustrative bag with a linear perforation and increased hole size;

FIG. 9 shows an illustrative bag with a linear perforation and non-circular holes;

FIG. 10 shows an illustrative extruded film with non-uniform perforations;

FIG. 11 shows an illustrative bag with a non-uniform perforation;

FIG. 12 shows an illustrative extruded film with non-continuous linear perforations;

FIG. 13 shows an illustrative bag with continuous linear perforation;

FIG. 14 shows the bag of FIG. 13 in an opened state;

FIG. 15 shows an illustrative extruded film with non-linear perforations;

FIG. 16 shows an illustrative bag with a non-linear perforation;

FIG. 17 shows an illustrative extruded film with non-continuous non-linear perforations;

FIG. 18 shows an illustrative bag with a non-continuous non-linear perforation; and

FIG. 19 shows the bag of FIG. 18 in an opened state.

### DETAILED DESCRIPTION

To provide an overall understanding of the systems, devices, and methods described herein, certain illustrative embodiments will now be described. For the purpose of clarity and illustration, the systems and methods will be described with respect to perforating an extruded film to produce perforated film roll stock. It will be understood by one of ordinary skill in the art that the systems and methods described herein may be adapted and modified as is appropriate, and that the systems and methods described herein may be employed in other suitable applications, such as for various materials, production processes, or perforation approaches that include simultaneously perforating any number of materials or layers of a material, and that such other additions and modifications will not depart from the scope hereof.

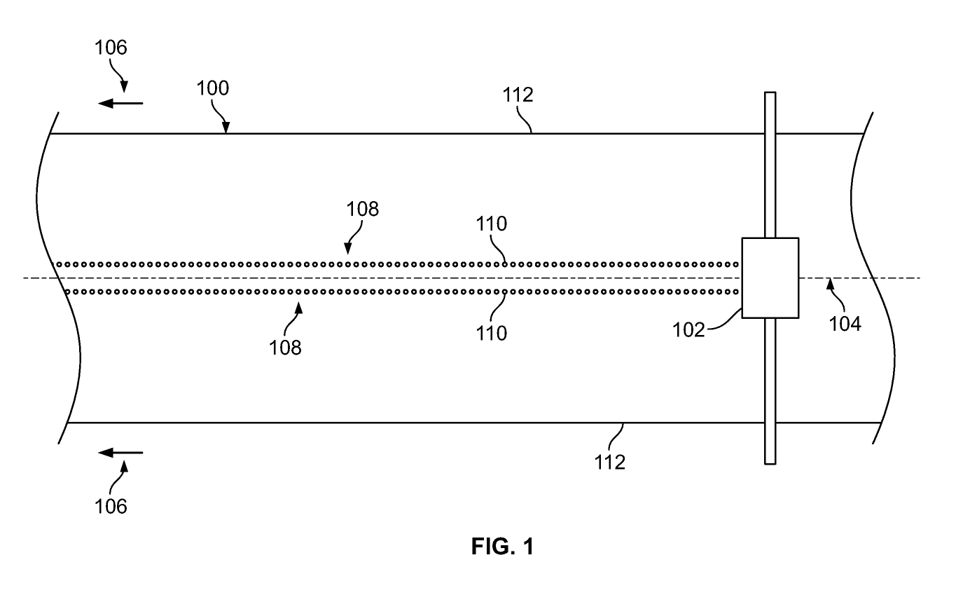

Systems, devices, and methods described herein provide for applying perforations to extruded film at a production or processing site and accommodating a variety of desired perforations for varied applications. In some embodiments, an extruded film is perforated prior to rolling into film roll stock for handling and transport. The extruded film may be perforated either as a flat sheet or after folding, for example after V-folding to create a two-layer sheet. FIG. 1 shows a flat sheet extruded film 100 being perforated while tracking through a production machine. As the film 100 passes through the machine in the direction indicated by arrows 106, the film 100 is perforated by the perforator 102. The perforator 102 creates two perforations 108, one on either side of the center line 104 of the film 100. Each of the perforations 108 is made of a series of holes 110 that are equally spaced from the center line 104 of the film 100, and the size and spacing of the holes 110 in each of the perforations 108 are substantially uniform. Thus, the perforator 102 creates two perforations 108 that are roughly mirror images of each other, as each hole 110 in one of the perforations 108 has substantially the same size and location relative to the center line 104 as a corresponding hole 110 in the other perforation 108.

The layout of the perforations 108 corresponds to a desired perforation design for individual bags. The perforator 102 is configured to cut holes 110 into the film 100 with a desired size, desired spacing between the holes, and desired spacing from center line 104 according to the desired design for each individual bag. To determine the correct perforation layout, the individual bag design is used and extrapolated to determine the perforation layout for a film that contains multiple consecutive bags. The perforation layout must be accurate so that bags having a desired dimension, for example a width or a length, cut from the film contain uniform perforations that correspond to the desired bag perforation design. The perforation layout is also defined such that the holes 110 of the perforations 108 register properly when the film 100 is folded along center line 104. Each hole 110 of one of the perforations 108, for example, corresponds to a hole 108 in the other of the perforations 108 such that the two holes in the two perforations are substantially aligned when the film 100 is folded.

The perforator 102 is configured to produce the perforations 108 according to a desired layout for a particular application of bags cut from extruded film 100. The perforator 102 can be adjusted to produce perforations with holes of different size, shape, spacing and alignment to meet different requirements. In certain implementations, the perforator 102 includes a mechanical perforating element such as a wheel, that is selected from a plurality of perforation elements to produce the type of perforation that is desired. For example, a perforating wheel may have a plurality of punches that punch holes into the extruded film 100 as the film tracks under the perforator 102 and the wheel rotates. A variety of wheels may be available that have punches of different sizes or different spacing between the punches, and the user may select a particular wheel to produce the hole size and the spacing between holes that is desired for a given application.

In certain implementations, the perforator 102 may include a laser perforation element with a programming module used to program and configure the laser element to produce the desired perforation. The perforator 102 in FIG. 1 may include a pulsed laser element that directs two beams into the film 100 at a set pulse rate and intensity to produce the desired size and spacing for the holes 110 in the perforations 108.

A single laser element can be programmed to adjust its operation and change the dimensions of the holes 110 and the spacing between the holes to produce a desired perforation for a particular application of the film 100. The laser perforator is pulsed between an on state in which a beam is directed into the film 100 to create a hole in the film and an “off” state in which no beam hits the film 100. The pulse rate and the beam produced in the “on” state determine the size and spacing of the holes 110. The pulse rate may be increased or decreased to increase or decrease the spacing between the holes 110 in each perforation. Increasing the pulse rate of the laser will cause the holes 110 to be spaced closer together, while decreasing the pulse rate will space the holes further apart if the tracking speed of the extruded film 100 is not changed. In addition, the intensity or beam width of the laser can be adjusted to change the size of the holes 110. Increasing the beam intensity or widening the beam of the laser apparatus will cause the holes 110 to be wider, while decreasing the intensity or narrowing the beam will result in smaller holes.

In addition to the pulse rate and intensity of a laser beam, the duty cycle of a pulsed laser can be programmed to adjust a perforation. The duty cycle corresponds to the percentage of an individual sequence of one on state and one “off” state in a single pulse that the laser is in the on state. An operator can adjust the duty cycle of the laser to produce a different perforation layout while keeping the pulse rate, track speed, and intensity unchanged. Increasing the duty cycle, for example by increasing the time of the “on” state and decreasing the time of the “off” state in each pulse, will create elongated holes with a smaller spacing between each hole. Likewise, decreasing the duty cycle will create narrower holes with a larger spacing between each hole.

Following perforation, the extruded film 100 may be processed to produce bags with perforated tear strips along the tops of the bags. The film 100 may be rolled into film roll stock and shipped to a filling site where the roll is cut into individual bag sheets that are filled and sealed. Alternatively, the film 100 may be cut into individual bag sheets and then packaged and shipped to a filling site where they are filled and sealed. Because the film roll stock is provided with the perforations 108 already on the extruded film 100, perforating equipment is not required at the processing site where bags are filled and sealed.

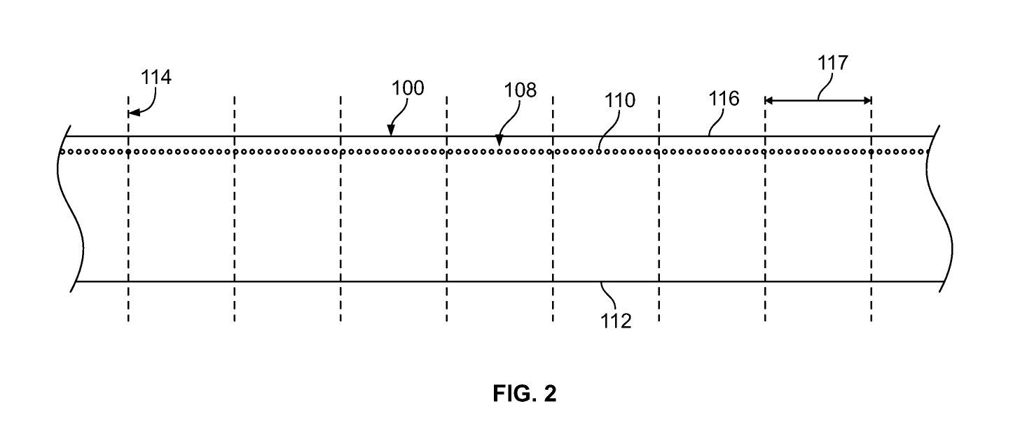

The film 100 may be folded and cut into individual sheets having desired dimensions that are then used to create individual bags. FIG. 2 shows the film 100 folded along the center line 104, aligning the two perforations 108. The folded film has a closed folded top 116 and an open bottom formed by the two adjacent edges 112. This creates a two-layer film with the holes 110 of the perforations 108 roughly aligned with corresponding holes on the second layer of the plastic film. The folded film can be cut along cut lines 114 to create individual bags each having a width 117.

In certain implementations, the film 100 is folded, for example folded in half along center line 104, prior to perforation. The folded film is then tracked by a perforator that applies the desired perforation through two layers of film simultaneously. For example, instead of tracking a flat sheet film by the perforator 102 as shown in FIG. 1, the film 100 can be folded in half as shown in FIG. 2 and then tracked past a perforator. This approach may be desired to reduce the number of perforation elements required and to facilitate accurate registration of perforation holes in the two layers of film. A perforator with a single perforating element, which may be a mechanical element or a laser, applies the perforation 108 to both layers of the folded film. The simultaneous application of the perforation 108 to the two layers of the folded film facilitates proper registration of the perforation holes 110 in the two layers of the film as the holes are applied by a single perforating element rather than two synchronized perforating elements as shown in FIG. 1.

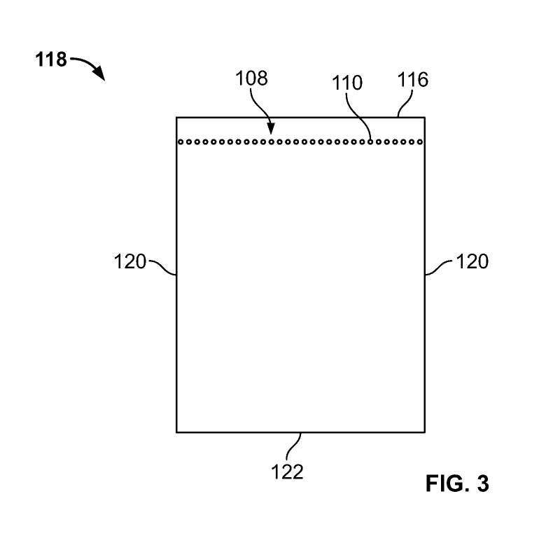

A bag 118 made by cutting along the cut lines 114 of the folded film is shown in FIG. 3. Depending on the machinery and mechanisms used to fill the bag 118, the sides 120 may be sealed to leave an open bottom 122 for filling, or alternatively one side 120 and the bottom 122 may be sealed to leave one of the sides 120 open for filling. The finished, sealed bag 118 has perforation 108 at the top of the bag, leaving a plastic tear strip above the perforation 108. The size and spacing of the holes 110 are selected such that this tear strip is strong enough to hold up to the handling and processing of the filled bag 118 without tearing, yet weak enough to break away when a user pulls at the folded top 116. The size of the holes and spacing between the holes are selected to produce a desired strength and tear away feasibility for the folded top 116, and the sizes and spacing chosen may depend on the material and weight of the bag 118. A desired perforation strength can be defined as a stress required to tear a perforation in a tensile test, for example a tensile test method according to the ASTM D-882 standard. In certain implementations, a particular perforation is tested by applying the perforation to a one-inch wide film sample and measuring the required stress applied perpendicular to the perforation to tear the perforation. In one application for a particular perforation, the desired stress is 5-6 lbs./in., but any other stress range may be targeted. For example, a stress between 0 and 5 lbs./in. may be desired, or a stress greater than 6 lbs/in. may be desired, or any suitable stress or range of stresses may be desired for a perforation. The configuration and layout of the perforation for a film and a bag cut for the film is adjusted in order to meet the target required stress.

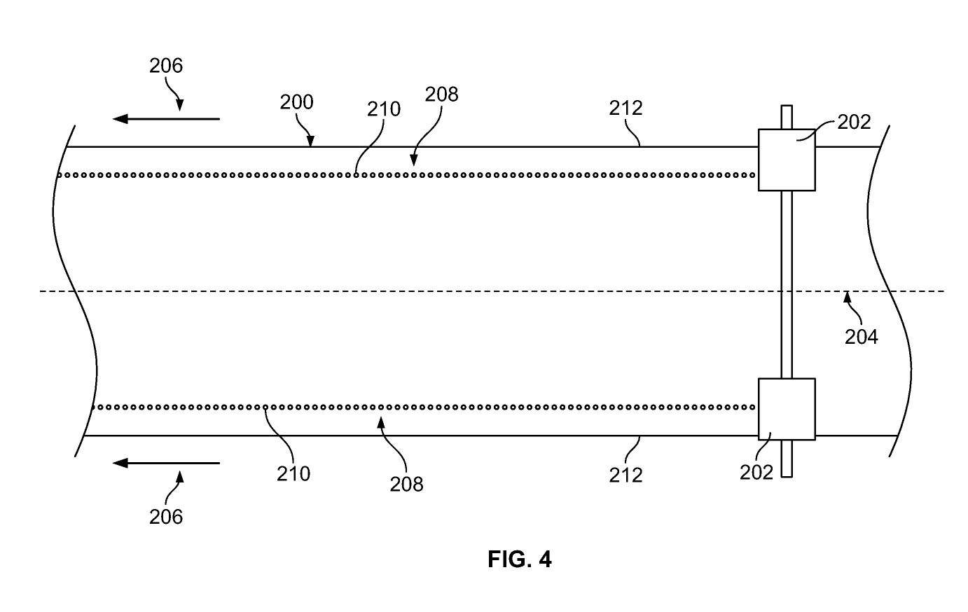

While the bag 118 shown in FIG. 3 has a folded top 116 and a sealed bottom 122, it may be preferable in some implementations to produce a bag that has a folded bottom and a sealed top. This type of bag can provide a stronger bottom for the bag in applications where a plastic seal at the bottom of the bag may not be strong enough. FIG. 4 shows a perforated extruded film 200 that may be used to create such a bag. The film 200 is perforated by two perforators 202 as it tracks through a production machine in the direction of the arrows 206. The resulting perforations 208 are located near the edges 212 of the film 200, rather than near the center line 204 of extruded film 200. As discussed above with respect to FIG. 1, the holes 210 that make up the two perforations 208 are designed for a specific purpose and application. The perforators 202 can be selected or programmed to create the desired size, shape and spacing of the holes 210. When the film 200 is folded along center line 204, the folded center line becomes the folded bottom of a bag, while the edges 212 come together to form an open top. As discussed above with respect to film 100, when film 200 is folded, the two perforations 208 align such that each hole 210 in the perforations is substantially aligned with a corresponding hole in the complementary perforation.

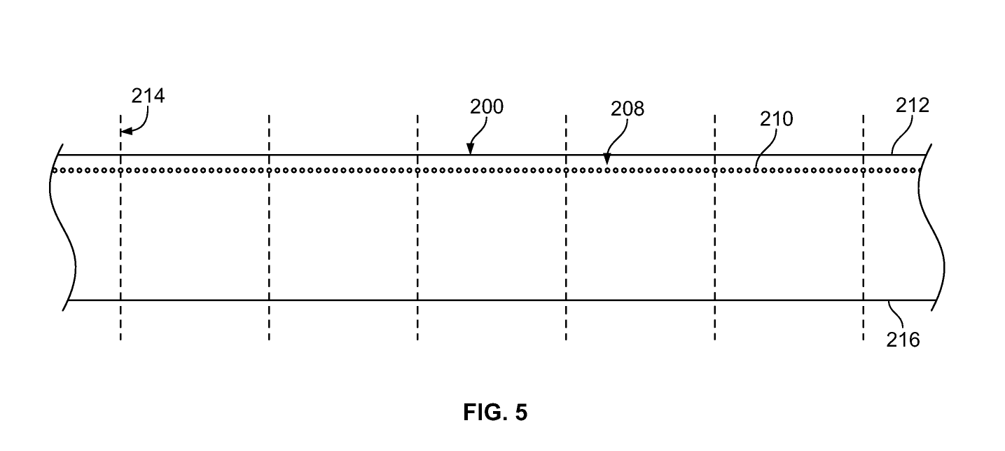

The folded film 200 is shown in FIG. 5 with the folded bottom 216, the open top created by the edges 212, and the aligned perforations 208 adjacent the open top. The folded film 200 may be cut along cut lines 214 to form individual bags. Before cutting, the folded film 200 may be rolled into a film roll to for shipment, or the bags may be cut out by cutting along cut lines 214 to ship packages of the individual bag sheets.

In certain implementations, the film 200 is folded in half and perforated in the folded form shown in FIG. 5 rather than perforating the flat sheet shown in FIG. 4. This approach reduces the two perforators 202 to a single perforator and alleviates complications that can arise from improper registration of the perforations 208. Because the film 200 is perforated near the outside edges 212 in the flat sheet form shown in FIG. 4, and not near the center line 204, there is an increased distance between the perforations that may make proper registration more difficult to achieve. Folding the film 200 before perforation and then simultaneously perforating both layers of the film may be desired to facilitate more accurate registration of the two perforations 208.

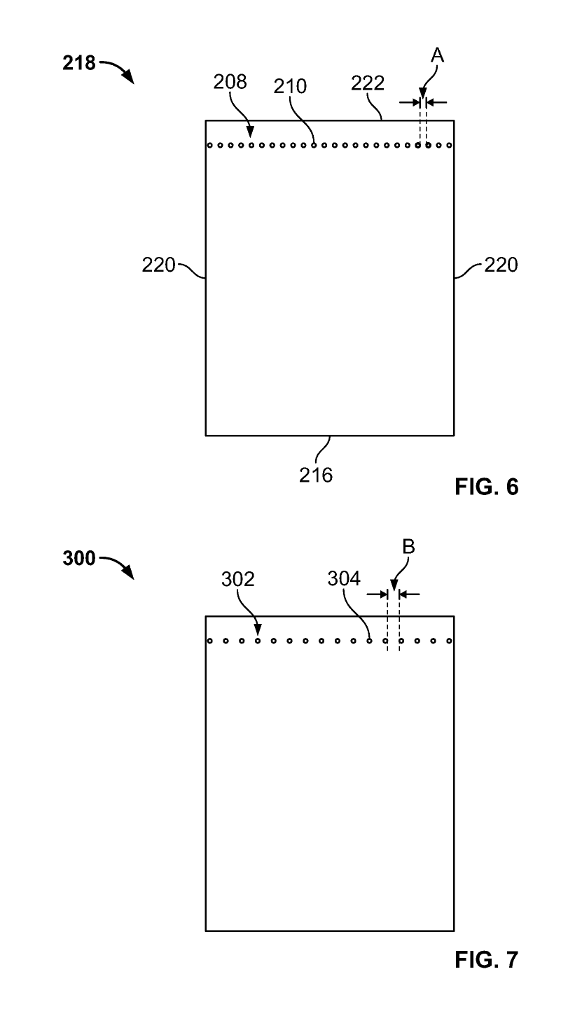

FIG. 6 shows a bag 218 made by cutting along the cut lines 214 in FIG. 5. The bag 218 includes a folded bottom 216, two sides 220, and an open top 222. When the bag is filled, the sides 220 may be sealed, and the bag may be filled through the open top 222. Alternatively, the top 222 may be sealed along with one of the sides 220 and the bag may be filled through the side that is left open. After filling, the finished sealed bag 218 has a perforation 208 adjacent the sealed top 222 to create a tear strip that facilitates removal of the folded top 222 and opening of the bag. As discussed above, the size of the holes 210 and the distance between the holes, shown by distance A in FIG. 6, can be configured to suit the strength needed for a particular application.

Multiple dimensions, such as perforation location, orientation, hole size, and hole spacing, discussed herein may be adjusted and configured to suit particular applications and needs for individual perforated bags. For a certain application, a desired bag perforation design is used to determine an extruded film perforation layout. The perforation layout is applied to produce a perforated extruded film that can be cut at set distances, which correspond to the desired dimension of individual bags, to create individual bags each having the desired perforation design.

A desired perforation design for a single bag, including the location, orientation, hole size, hole spacing, and any other suitable features of a perforation, is extrapolated to determine the timing and configuration of an extruded film perforating element. For example, the timing and settings of a laser element are determined for a single perforation for an individual bag. The timing and settings are then replicated to create a repeating pattern of the individual bag design. For uniform, linear perforations that do not vary, this repeating pattern will result in a uniform operation routine of the laser. For non-uniform or non-linear perforated bags, the repeating pattern is a series of individual operating routines, with the beginning of each routine corresponding to beginning of an individual bag perforation and the end of each routine corresponding to the end of an individual bag perforation.

FIG. 7 shows a bag 300 with a perforation 302 having dimensions configured to suit a particular application. Perforation 302 is made up of holes 304 that have a size similar to the holes 210 discussed above with respect to FIG. 6. In perforation 302, the holes 304 are spaced a distance B apart, and the distance B is larger than the spacing distance A discussed above with respect to FIG. 6. The larger distance between the holes 304 requires more applied force to tear the top of the bag along the perforation 302 and may be desired for applications in which a heavier duty bag is desired. For example, the bag 300 shown in FIG. 7 may be larger, heavier, or handled more than the bag 218 shown in FIG. 6. For such an application, the holes 304 may need to be spaced the distance B apart in order to stand up to handling and processing when the bag 300 is full.

While a bag with perforation holes spaced by the distance A shown in FIG. 6 may create an easy tear strip for a user to remove, this spacing leads to complications for heavier contents, as the bag may unintentionally open during handling. Spacing the holes wider apart requires more force to be applied to tear open the bag since a user must tear through a wider piece of material between each hole. The increased applied force required for removal of the tear strip when the holes are spaced by distance B may be an acceptable trade off as it also adds strength to the bag that reduces the likelihood of unintentional opening during handling.

Producing the perforation 302 shown in FIG. 7 on a film roll stock requires a different perforator configuration than is required to produce the perforation 208 shown in FIG. 6. An individual bag perforation design is used to determine the extruded film perforation layout that the perforator is configured to produce. If a mechanical perforator is used, a different perforating wheel or other mechanical component with punches spaced farther apart could be used to create the perforation 302. If a laser perforating device is used, either the laser or the track speed of the roll film stock through the perforator could be varied. For example, the speed of the extruded film tracking past the perforator could be increased while the pulse rate of the laser remains the same, thus producing the wider spacing between the holes 304 and the perforation 302. Increasing the track speed will also result in holes that are slightly elongated, as each pulse of the laser covers a slightly longer distance on the film. The duty cycle of each pulse could be decreases to maintain the same hole shape when track speed increases and pulse rate remains constant. Alternatively, the track speed of the extruded film could remain the same, and the pulse rate of the laser could be slowed to increase the time between individual pulses, thus resulting in the increased spacing between the holes 304.

In certain implementations, a bag with multiple lanes of perforation is produced, and the layout of one of the two lanes differs from the other. For example, a bag can include a closure feature, such as an adhesive or interlocking strip, that allows for sealing the bag after it has been opened. Such a bag can include two lanes of perforation, one above the closure feature and one below. The two lanes of perforation are provided to give the user an option to either open only at the top perforation and reclose the bag or to open at the bottom perforation to remove both the top tear strip and the closure feature. To reduce the chance that the user will accidentally tear the bottom perforation when trying to only open the top, the layouts of the two perforation lane are selected such that the bottom perforation is more difficult to remove. For example, the bag may have a top perforation layout like the perforation 208 shown in FIG. 6 and have a second perforation layout like the perforation 302 shown in FIG. 7, with a closure feature between the two perforations. Because the perforation 208 is easier to tear than the perforation 302, the user can apply only enough force to tear the top perforation while leaving the bottom perforation in tact and leaving the closure feature on the bag. In addition to the spacing between holes in the two lanes of perforation, the hole shapes and pattern of the two lanes may differ, and one lane may be continuous while the other is non-continuous, or one lane may be linear while the other is non-linear, to suit a particular application.

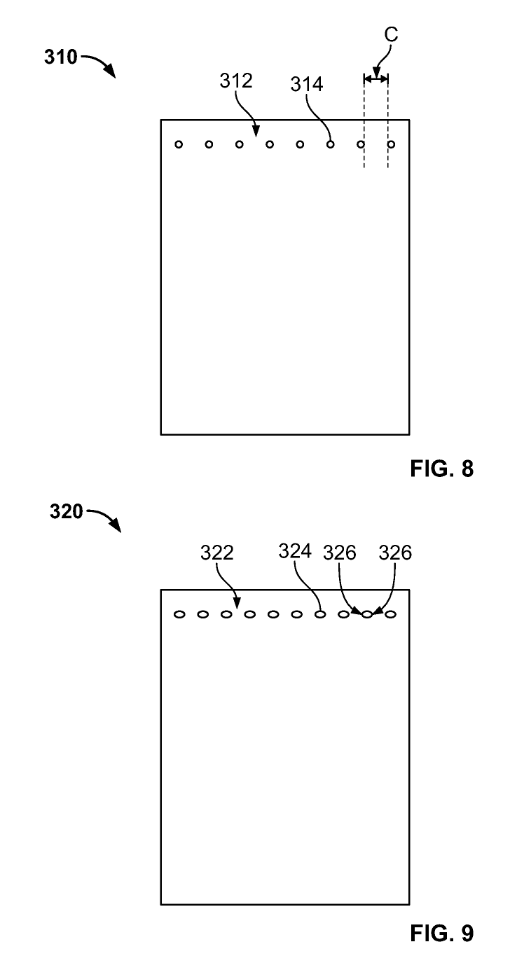

In addition to the spacing between holes of a perforation, the size of the holes may also be varied to fit a particular application. A perforation with larger holes may require the same amount of force to start a tear as a perforation with smaller holes and similar spacing, but may be easier to tear once the tear strip is begun. A perforation with increased hole size may be preferable, for example, for a heavy duty bag that must stand up to heavy loads and handling while providing a user with a tear strip that can be removed without too much extra effort. FIG. 8 shows an illustrative bag 310 that may be used for such an application. The bag 310 has a perforation 312 made up of holes 314. The holes 314 are larger in size than the holes 304 shown in bag 300 of FIG. 7. The holes 314 are separated by a distance C, which may be the same, larger, or smaller than the spacing distance B shown in FIG. 7. The size of the holes 314 may not substantially affect the initial force required to start a tear, and toe required initial force for the bag 310 may be substantially the same as the bag 300. However, once the tear is started the perforation 312 is easer to remove from the top of the bag as the larger holes 314 carry more momentum from the force applied by a user.

As discussed above with respect to the spacing between holes of a perforation, producing holes of different sizes requires changing the configuration of a perforator or a tracking machine used to create a film roll stock with the desired hole size. If a mechanical perforator is used, a mechanical element, such as a wheel, may be selected with larger punches to produce the desired size of the holes 314. A mechanical perforator with tapered punches, for example conical punches, may be used, and the size of the holes 314 can be controlled by controlling the depth to which the punches penetrate the extruded film. If a laser perforating device is used, the width and intensity of a pulsed laser beam can be adjusted to produce a wider hole 314 on each pulse of the laser. The focal length of the laser may be adjusted by changing or adjusting lenses to produce a desired hole size. The pulse rate of the laser and tracking speed of the roll stock through the machine can also be dialed in to produce the desired distance C between the holes 314.

While the perforated films and bags discussed above include circular perforation holes, a perforation for a particular application may be further customized by producing individual perforation holes of different shapes. In certain implementations, a perforation with noncircular holes can be used for a bag so produce desired strength and tear away feasibility. FIG. 9 shows bag 320 with a perforation 322 made up of noncircular holes 324 for such an application. The holes 324 are oval shaped and have ends 326 that concentrate stresses when a user applies force to the tear strip of the bag, thus making it easier to tear along the perforation 322 once the tear is started. While circular holes may distribute applied forces evenly around the perimeter of the hole, the holes 324 focus applied forces at the ends 326, and thus concentrate an applied force in a line along perforation 322. As a result, a lower force may be required to tear the perforation 322 once the tear is begun. In addition to the oval-shaped holes shown in FIG. 9, any other suitable non-circular hole shape, for example diamond or square holes, may be used to produce stress concentrations and lower tearing force.

To produce the perforation 322, the configuration of a perforator or bag tracking machine may be varied relative to a configuration that produces circular holes. For mechanical perforators, the mechanical perforating element is selected with punch holes having the desired shape for the holes 324. For a laser perforator, a production machine can operate at an increased tracking speed so that each pulse of the laser perforator creates an elongated hole 324 in the bag rather than a clean circular hole. Alternatively, the “on” period of a pulsed laser can be increased slightly to produce the elongated holes 324.

The bags and roll stock discussed above contain perforations with uniform size, shape and spacing between holes of a single perforation. The systems, method and devices disclosed herein also provide for creating a roll stock with perforations that are non-uniform and have either different shapes, sizes, spacing, or a combination thereof in a single bag perforation. The ability to configure a tracking machine and perforator to create a non-uniform perforation may further increase the ability of a machine to accommodate different requirements for various applications of a particular bag. This variability allows the user to dial in exactly the type of perforation desired and enhances the user's ability to fit the requirements of a particular application for a film roll stock and for bags subsequently cut from the roll stock.

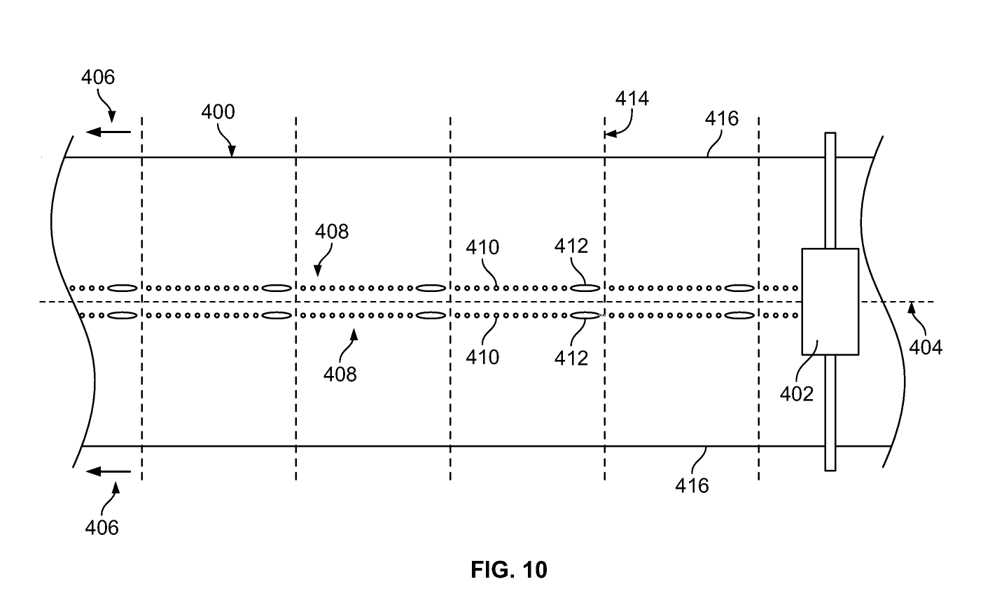

In certain implementations, a film roll stock may be produced with a linear perforation made of holes that have uniform spacing but non-uniform shapes. FIG. 10 shows extruded film 400 that is perforated on either side of center line 404 as it passes by perforator 402. The perforations 408 created by perforator 402 are composed of two types of holes, circular holes 410 and elongated holes 412.

The perforator 402 is configured such that, as the film 400 tracks through the machine in the direction indicated by arrows 406, the perforator 402 produces sets of circular holes 410 separated by elongated holes 412. For example, a laser perforator may be used, and the pulse rate and period of the laser may vary as the extruded film 400 tracks under the perforator 402 to produce the desired pattern. The series of circular holes 410 may be produced by using a first pulse rate and pulse intensity to produce the desired holes, and the “on period of the pulsed laser may be increased periodically for a single pulse to produce the elongated holes 412. The timing of the changes in the perforator 402 is set such that the circular holes 410 are placed into the extruded film 400 for a set distance and are followed by the elongated hole 412. As a result of the timing, bags formed by cutting along the cut lines 414 include a series of circular holes 410 adjacent an elongated hole 412 that separates the circular holes 410 from a side of the bag created by a cut along a cut line 414. When bags are cut from the extruded film 400, whether at the site where the film 400 is produced or at a filing site, the bags may be folded along center line 404 to create a folded top and an open bottom formed by the adjacent edges 416.

The perforation layout shown in FIG. 10 is determined using a desired perforation design for an individual bag. The perforation design includes an elongated hole of a desired width spaced from one side of the bag and a series of substantially circular holes between the elongated hole and a second side of the bag. Using this design, a perforating element configuration is determined to produce the perforation for a single bag. In mechanical implementations, the perforating element includes a single punch for the elongated hole followed by the desired number of circular punches for the circular holes. In a laser perforating implementation, the perforating element configuration includes programming the laser with a single long pulse that produces the elongated hole, followed by a series of short pulses that produce the circular holes. The track speed of the film is used to determine the timing of the long pulse and the short pulses, or the timing of one rotation of a mechanical perforating element, so that the overall cycle covers a single bag dimension, for example a width or a length.

The perforations 408 require precise definition of a perforation layout to properly align the circular holes 410 and the elongated holes 412 when the film 400 is folded. The two perforations 408 in the layout are created such that each elongated hole 412 in one of the perforations 408 aligns with an elongated hole 412 in the other of the perforations 408 when the film 400 is folded. Likewise, each series of circular holes 410 in a first perforation aligns with a corresponding series of circular holes 410 in the second perforation. The perforation layout for the film 400 is used to precisely configure the perforator 402 to create the perforations 408 in a uniform manner, aligning each elongated hole with a corresponding elongated hole. The alignment and proper registration of the holes is needed to produce individual bags with effective perforations and tear strips.

In certain implementations, the film 400 is folded first and perforated second. After folding the film 400 along center line 404, a single perforating element applies the perforations 408 into the two layers of the film simultaneously. This approach may be preferred for the perforation layout shown in FIG. 10, as it facilitates proper registration that is needed to align each elongated hole 412 with its corresponding elongated hole and thus produce an effective perforation.

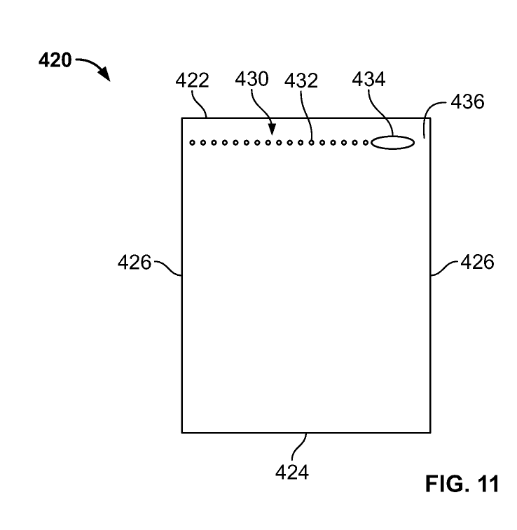

A bag 420 that may be cut out of the film 400 is shown in FIG. 11. The bag 420 includes a folded top 422 that is created when the film 400 is folded along the center line 404, two sides 426, and an open bottom 424. The bag may be filled through one of the sides 426 or may be filled through the bottom 424, depending on the requirements of a particular application. The bag 420 may also be produced from a film with peripheral perforations along outside edges of the film, rather than along the center of the film, and then folded and filled through an open top 422. Regardless of the method used to fill the bag, the finished filled bag includes a tear strip created by perforation 430 near the top 422 of the bag.

The elongated hole 434 is separated from one of the sides 426 of the bag 420 by spacing section 436. The combination of the elongated hole 434 and the spacing section 436 provides a tear strip at the top of the bag 420 that is easier to tear than a perforation made of just uniform circular holes across the top of the bag. The perforation 430 requires a user to apply enough force to rip spacing section 436 and open the elongated hole 434. The shape and size of the elongated hole 434 then adds momentum to the tear as the large void allows the user to apply more force before reaching the circular holes 432. The added momentum and increased force result in an easier tear through the circular holes 432 than of be possible if the circular holes 432 simply extended across the full width of the bag. Thus, as soon as the user applies adequate force to overcome the spacing section 436, the elongated hole 434 allows a user to lead into the circular holes 432 with an increased force to more easily rip through the rest of the perforation 430.

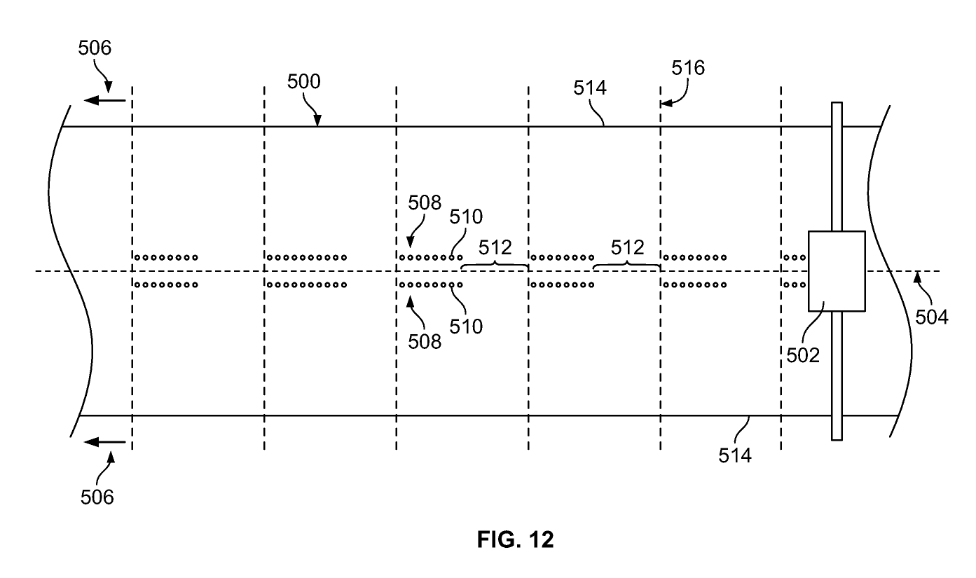

While the perforations on the films and bags discussed above are continuous and extend across substantially the full width of individual bags, non-continuous perforations may also be applied. FIG. 12 shows extruded film 500 into which non-continuous perforations 508 are cut as the film 500 tracks under perforator 502 in the direction shown by arrows 506. The perforations 508 are made of holes 510 on either side of the center line 504 of the film 500 but do not cover the entire length of the extruded film 500. The perforations 508 are separated from each other by unperforated portions 512. With this pattern, the film 500 can be cut along cut lines 516 to produce individual bags that are perforated over approximately half of the width of the bag, with the other half being an unperforated portion 512

The perforation layout shown in FIG. 12 is determined using a desired perforation design for an individual bag. While each bag perforation includes only one uniform type of hole 510, the non-continuous nature of the perforations 508 requires a perforating element to alternate between active, to produce the holes 510, and non-active states, to produce the unperforated portions 512. In addition, the number of mechanical punches or laser pulses in each active period is set to produce the desired number of holes 510 in each perforation 508. The timing of each active and non-active period is defined using the track speed to ensure that the distance across a single perforation 508 and unperforated portion 512 corresponds to a single bag dimension. If the timing is not set precisely or is not adjusted to the track speed used, cuts along cut lines 516 will not produce uniform individual bags with the desired perforation across about half of the bag. As discussed above with non-uniform perforations, the perforation layout for film 500 is defined to precisely align corresponding perforations 508 and align corresponding unperforated portions 512 when the film 500 is folded.

In certain implementations, visual cues on the film 500 are used to accurately time the application of the perforations 508. A marker, such as an opaque or an infrared mark, is applied to the film 500 at predetermined distances along center line 504 when the film 500 is extruded. The predetermined distance between the markers is set to correspond to the desired dimension between cut lines 516. Each marker serves as a signal to the perforator 502 to trigger the on state of a perforating element and apply a perforation 508. A camera or other image processor on the perforator 502 detects each mar on the film 500 and triggers the perforator 502. After each trigger, the perforator 502 is set to apply the perforations 508 for a set distance along the center line 504 and then enter the “off” state until another marker is detected.

To produce the perforation pattern shown in FIG. 12, the perforator 502 is configured to cut holes only half the time that the extruded film 500 is tracking through the machine. For a mechanical perforator, a mechanical element such as a wheel can be chosen with perforation punches only covering half of the perimeter of the wheel, so that a full rotation of the wheel creates a perforated portion 508 followed by an unperforated portion 512 that covers substantially the same distance along the film 500 as the perforated portion 508. A mechanical wheel with punches along the full perimeter of the wheel may also be used, and the wheel may be oscillated toward and away from the film. The movement of the wheel is timed such that the perforated portions 508 and unperforated portions 512 correspond to desired dimensions. For a laser perforator, the laser can be configured to pulse for only half the time that the extruded film 500 is passing through the machine. An active period for the pulsed laser creates the perforation 508, and an inactive period for the laser pulse leaves the unperforated portion 512. To create bags from the film roll stock, the film 500 can be cut along cut lines 516 and folded along center line 504 to create a folded top and an open bottom formed by the adjacent sides 514.

In certain implementations, the film 500 is folded along center line 504 prior to perforation, and a single perforating element applies the perforations 508 to the two layers of the film simultaneously. This approach may be preferred, as proper alignment and registration of the perforations 508 and unperforated portions 512 may be more easily achieved. If a marker on the film 500 is used, the folded film also requires triggering of only a single perforating element rather than simultaneous triggering of two perforating elements in response to a detected marker.

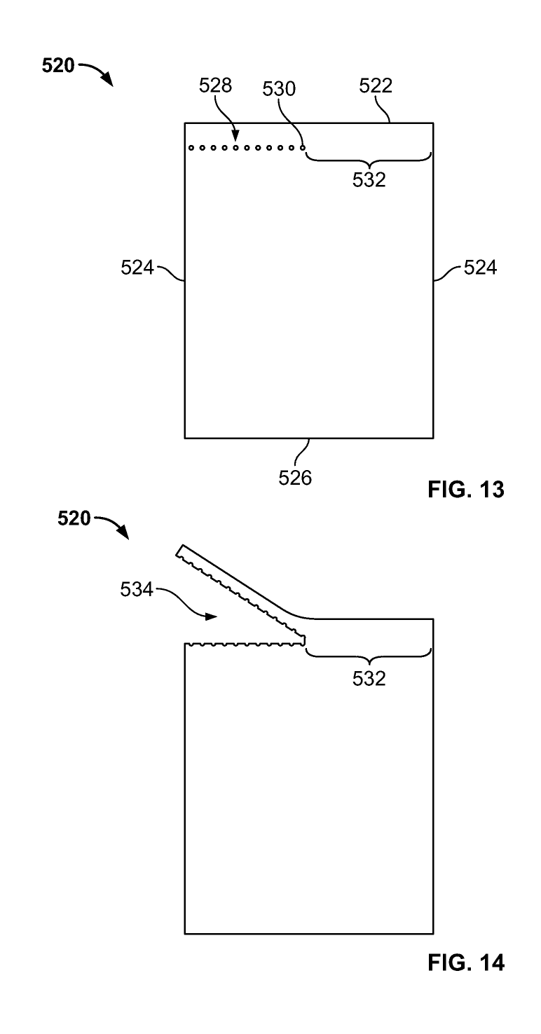

FIG. 13 shows a bag 520 that may be created, for example, by cutting along cut lines 516 in the extruded film 500. The bag 520 includes a folded top 522, two sides 524, and a bottom 526. Adjacent to top 522 is a perforation 528 that is made up of holes 530. Notably, the perforation 528 does not extend all the way across the bag 520 due to the non-continuous perforation of the film roll stock from which the bag 520 is cut. Thus, the perforation 528 includes an unperforated portion 532 that covers substantially half of the top of the bag 520. This may be desirable because it allows the user to tear along perforation 528 and open the bag to remove the interior contents of the bag 520 without completely removing the tear strip that is adjacent to top 522. This facilitates disposal of the tear strip after the contents of the bag 520 are emptied.

When a user applies force to the tear strip and tears along the perforation 528, the tear strip does not come completely off of the bag, as shown in the open bag in FIG. 14. In FIG. 14, the perforation has been torn to create opening 534 which acts as a pour spout for the bag 520. The unperforated portion 532 remains intact so that the tear strip remains connected to the bag. This facilitates disposal of the tear strip as the tear strip and bag are still one piece and may be easily handled after emptying the bag 520.

The film roll stock and bags with perforations discussed above all incorporate linear, one-dimensional perforations that may be created by a single-axis perforator head. While the inclusion of a laser perforator allows for variability in the size, shape, and spacing of holes of a perforation, a single-axis head is still limited to linear perforation when used on a linear tracking machine. In certain implementations, a two-axis perforator head can be used with a laser perforating element to provide even greater variability. Such a perforator allows a user to create a variety of shapes for the overall perforation as well as configure the shape, size, and spacing of the individual holes that make up the perforation.

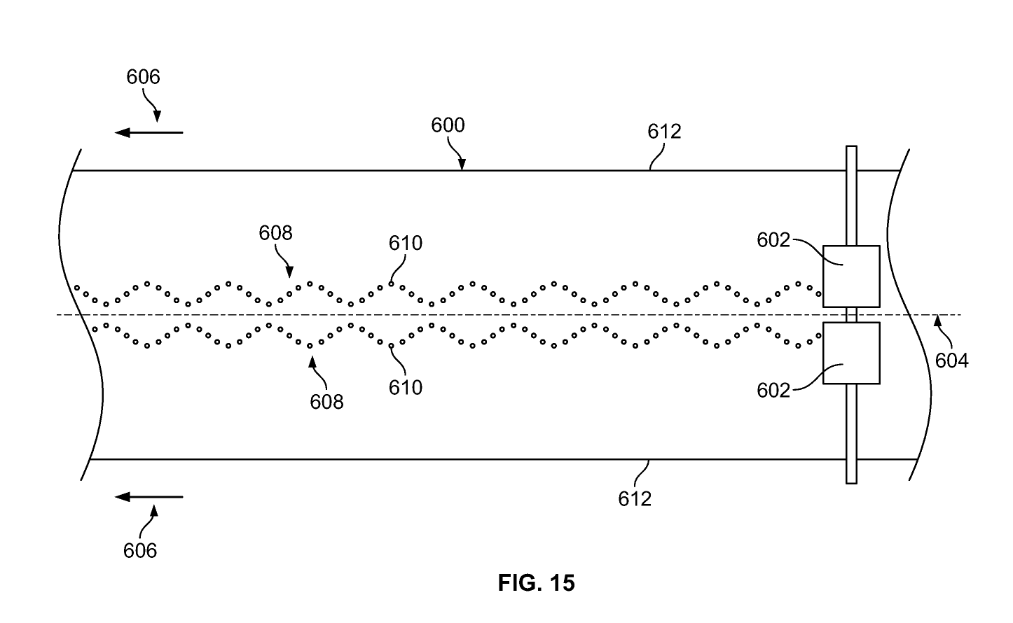

FIG. 15 shows an embodiment with two-axis perforators 602 that create non-linear perforations 608 on film 600 as the film tracks through a production machine in the direction shown by arrows 606. The machine shown in FIG. 15 includes two perforators 602, one located on each side of the center line 604 of the film 600. As the film 600 tracks through the machine, the perforators 602 are able to move independently of each other from center line 604 towards the side 612 of the film 600 and then back toward the center line 604. The resulting holes 610 in perforations 608 create substantially symmetric wave patterns on either side of the center line 604. When individual, bags are cut out of the film 600, the bags can be folded on center line 604 to substantially align each of the perforations 608 and create a wave perforation. The perforators 602 are configured according to a perforation layout to align the perforations 608 so that the wave perforations on the film 600 are symmetrical and register properly when the film 600 is folded. In certain implementations, proper registration of the perforations 608 is facilitates by first folding the film 600 and then applying the perforations 608 simultaneously to the two layers of the film.

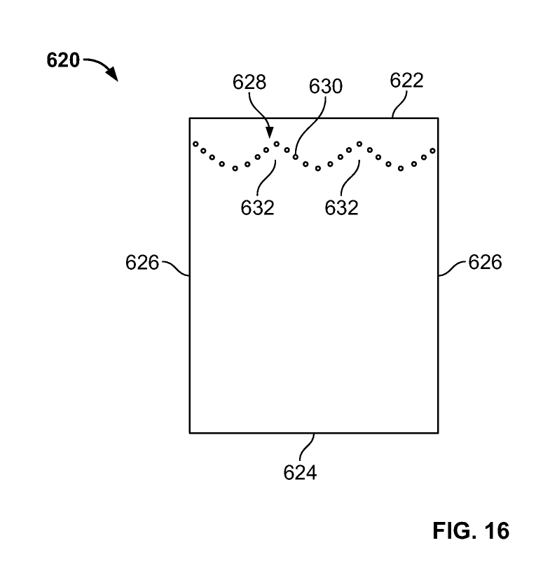

A bag that can be created from the film 600 is shown in FIG. 16. The bag 620 includes a top 622, two sides 626, and a bottom 624. Adjacent the top 622 is a wave shaped perforation 628 made up of holes 630. The wave shape of the perforation 628 leaves a non-linear opening on the bag 620 when a user tears along the tear strip and removes the top 622. This non-linear opening may he preferable, for example, to leave tabs 632 that a user may grab on to for lifting and moving bag 620 after the top 622 has been removed by tearing along the perforation 628. The flaps may also be desired to facilitate closing and tying the bag without requiring the use of any drawstrings or other tying features. As discussed with respect to previous bag designs, the perforation layout on the film 600 must be determined to produce uniform bags with the desired perforation. The timing of the movement of the perforators 602 is set such that configuration of the perforations 608 produces uniform bags, such as bag 620, that have two flaps substantially centered on the bag.

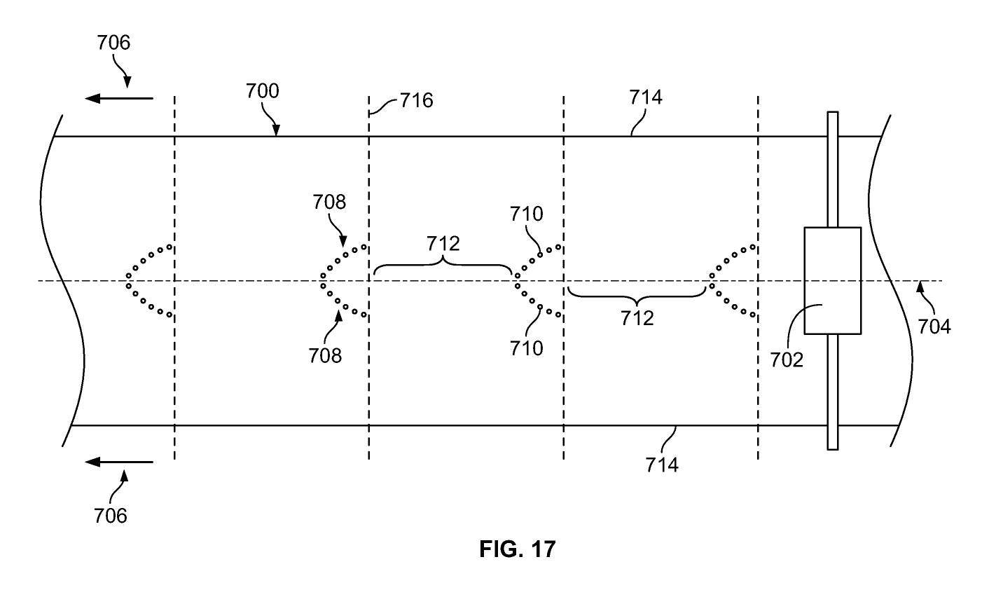

A two-axis perforator may also be used to create a non-linear, non-continuous perforation to add even greater variability to the types of perforations that can be created on a film roll stock. FIG. 17 shows a film 700 that includes one such perforation. As film 700 passes through a production machine in the direction of arrows 706, the perforator 702 creates a non-linear, non-continuous perforation 708 on either side of the center line 704 of the film 700. As the film 700 tracks through the machine, a series of holes 710 is periodically cut into the film 700 in an arcing shape to form perforations 708. The perforations 708 are separated from each other by unperforated portions 712 to create a series of bags each containing an unperforated portion 712 and an arced perforation 708. When the film 700 is cut along the cut lines 716 and folded along center line 704, individual bags are created with a folded top and an open bottom formed by adjacent edges 714. As discussed above with respect to FIG. 12, markers on the film 700 are used in some implementations to trigger the perforator 702 and produce the non-continuous perforations 708 shown in FIG. 17. The film 700 may also be folded prior to perforation by a single perforating element to facilitate proper registration of the perforations 708.

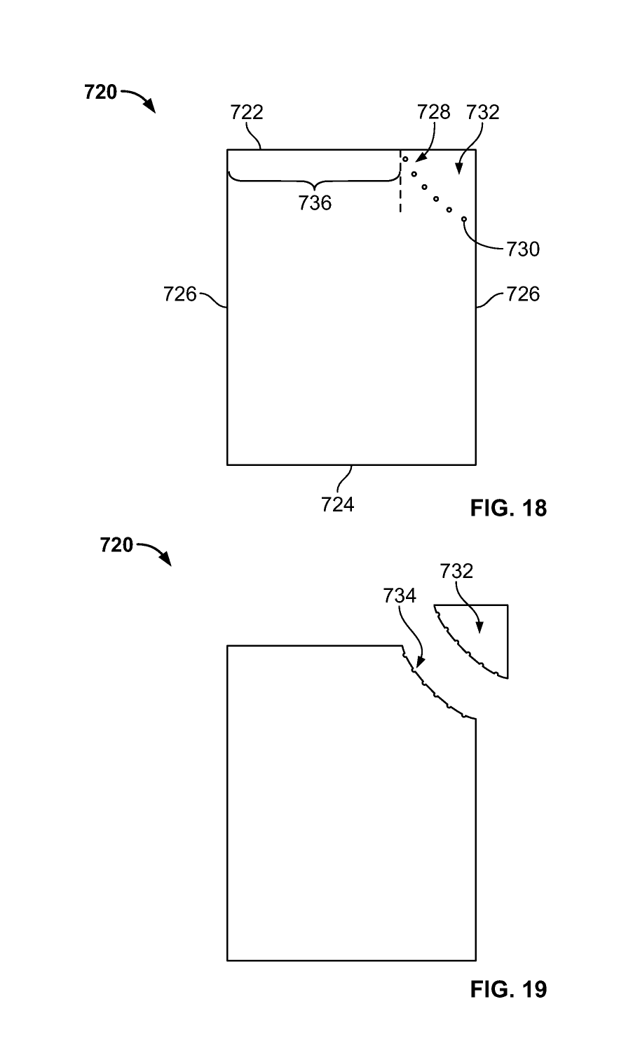

FIG. 18 shows a bag 720 that may be created by cutting along the cut lines 716 in FIG. 17. The bag 720 includes a top 722, two sides 726, and a bottom 724. Along the top 722 is an unperforated portion 736 and a corner portion 732 that is separated from the rest of the bag by the arced perforation 728 made of holes 730. A user may apply a force to the corner portion 732 to tear along the perforation 728 and completely remove the corner portion 732 from the bag This leaves an open corner left by the removed corner portion 732 and a partially closed top of the bag left by unperforated portion 736. FIG. 19 shows bag 720 after the corner portion 732 has been removed. The removal of the corner portion 732 creates a pour spout 734 in the corner of the bag 720. The pour spout 734 may facilitate cleaner, more controlled removal of the contents of the bag 720, and thus may be preferable for a certain implementation, for example, in gardening or lawn bags in which it is desired to have increased control when pouring the contents of the bag 720.

It is to be understood that the foregoing description is merely illustrative and is not to be limited to the details given herein. While several embodiments have been provided in the present disclosure, it should be understood that the disclosed systems, devices, and methods, and their components, may be embodied in many other specific forms without departing from the scope of the disclosure.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated. above, including any components thereof, may he combined or integrated in other systems. Moreover, certain features may be omitted or not implemented.

Examples of changes, substitutions, and alterations are ascertainable by one skilled in the art and could he made without departing from the scope of the information disclosed herein.

What is claimed is:

1. A method for producing a perforated extruded film, comprising:
defining a bag perforation design;
determining a perforation layout for an extruded film, wherein the perforation layout comprises a plurality of consecutive perforations matching the perforation design;
configuring a perforating element to produce the perforation layout on the extruded film; and
tracking the extruded film by the perforating element, wherein the perforating element applies the selected perforation layout as the extruded film tracks by the perforating element.

2. The method of claim 1, wherein determining a perforation layout comprises defining a shape of holes in a perforation.

3. The method of claim 2, wherein the shape is a non-circular shape comprising points that focus stresses.

4. The method of claim 2, wherein more than one shape is defined for a perforation having non-uniform hole shapes.

5. The method of claim 1, wherein determining a perforation layout comprises defining a spacing between holes of a perforation.

6. The method of claim 5, wherein the defined spacing varies along the extruded film.

7. The method of claim 1, wherein determining a configuration layout comprises defining a non-linear pattern for a perforation.

8. The method of claim 1, wherein the configuration layout is determined based on a track speed of the extruded film through a production machine.

9. The method of claim 1, further comprising determining a repeating pattern of individual operating routines for the perforating element.

10. The method of claim 9, wherein determining the repeating pattern comprises determining a timing of the individual operating routines such that each operating routine covers a predetermined distance along the extruded film.

11. The method of claim 10, wherein the predetermined distance comprises a desired dimension for an individual bag.

12. The method of claim 1, wherein the perforating element comprises a laser.

13. The method of claim 12, wherein configuring the perforating element comprises programming at least one of a beam width, beam intensity, pulse rate, and duty cycle of the laser.

14. The method of claim 1, wherein the perforating element comprises a mechanical perforator.

15. The method of claim 14, wherein configuring the perforating element comprises selecting at least one of a punch size, punch spacing, and punch shape of the mechanical perforator.

16. An extruded film for production of perforated bags prepared by a process comprising the steps of:
defining a bag perforation design;
determining a perforation layout for an extruded film, wherein the perforation layout comprises a plurality of consecutive perforations matching the perforation design;
configuring a perforating element to produce the perforation layout on the extruded film; and
tracking the extruded film by the perforating element, wherein the perforating element applies the determined perforation layout as the extruded film tracks by the perforating element.

17. The extruded film of claim 16, wherein the perforation layout is applied by a mechanical perforating element.

18. The extruded film of claim 16, wherein the perforation layout is applied by a laser perforating element.

19. A system for producing a perforated extruded film, comprising:
a laser configured to apply a desired perforation layout to an extruded film, said perforation layout comprising a plurality of consecutive individual bag perforations;
a tracking mechanism configured to track the extruded film by the laser; and
a programming module configured to control the laser as the extruded film tracks by the laser;
wherein the programming module is configurable by a user to produce the desired perforation layout.

20. The system of claim 19, wherein the programming module is configurable to produce at least one of a non-uniform, non-continuous, or non-linear perforation layout.
